(19) United States
(12) Patent Application Publication
(10) Pub. No.: US 2014/0157391 A1
(43) Pub. Date: Jun. 5, 2014

(54) SECURITY CERTIFICATION AND STORAGE COMBINED APPARATUS HAVING WIRELESS COMMUNICATION FUNCTION

(71) Applicant: Saferzone Co., Ltd., Daejeon (KR)

(72) Inventors: Jae Sik CHOI, Daejeon (KR); Chul Su KIM, Daejeon (KR); Won Jang SON, Paju-si (KR); Chang Hoon KWON, Yongin-si (KR)

(21) Appl. No.: 13/942,181

(22) Filed: Jul. 15, 2013

(30) Foreign Application Priority Data
Dec. 5, 2012 (KR) 10-2012-0140199

(51) Int. Cl. H04W 12/06

(52) U.S. Cl. CPC H04W 12/06
USPC 726/9

(57) ABSTRACT

A security certification and storage combined apparatus provides a wireless communication function in that it can provide a function of a security certification and a function of a storage device through a general terminal having an USB communication function and a mobile device, which is not equipped with an USB port, and it can exchange data with the mobile device or change the data received from the mobile device through a wireless communication module, thereby easily implementing the certificate verification interface.

### CROSS REFERENCE

Applicant claims foreign priority under Paris Convention and 35 U.S.C. §119 to Korean Patent Application No. 10-2012-0140199, filed 5 Dec. 2012, with the Korean Intellectual Property Office, where the entire contents are incorporated herein by reference.

### BACKGROUND OF THE INVENTION

1. Field of the Invention

The present invention relates to a security certification and storage combined apparatus having a wireless communication function. More particularly, the present invention relates to a security certification and storage combined apparatus having a wireless communication function in that it can provide a function of a security certification and a function of a storage device through a general terminal having an USB communication function and a mobile device, which is not equipped with an USB port, and it can exchange data with the mobile device or change the data received from the mobile device through a wireless communication module, thereby easily implementing the certificate verification interface.

2. Description of the Prior Art

Recently, according to the vitalization of an e-commerce, the importance on the security of secret information such as a personal information and a financial information etc. has been heightened. Accordingly, a security token capable of safely storing the secret information such as a digital signature generation key etc. therein is widely used. Also, the security token can generate the digital signature key and the digital signature and verify them through the process and the encryption operating device, which are installed in the equipment.

This security token has been developed in the form of a device coupled to a security USB for data security. Also, it has been developed in a type capable of safely storing and managing the important secret information such as a security data or a certificate verification etc.

However, the conventional security token combination type security USB is configured to connect a PC through an USB connector. Accordingly, there is a defect in that it cannot be used in the mobile devices such as a smartphone, and a tablet PC etc., which are not equipped with an USB port.

Where the certificate verification is stored in a storage unit for storing a general data with software, in order to prevent the vulnerability of the security, the security token for storing the certificate verification in a hardware is used. However, since the existed security token can be connected to the equipment through only the USB interface, it cannot be used in the mobile device. Accordingly, there is a serious problem in the mobile device having a weak security.

### SUMMARY OF THE INVENTION

Accordingly, the present invention has been made to solve the above-mentioned problems occurring in the prior art, and an object of the present invention is to provide a security certification and storage combined apparatus having a wireless communication function capable of freely using a certification and storage apparatus having a security memory and a security token together even in a mobile device which is not equipped with an USB interface.

Another object of the present invention is to provide a security certification and storage combined apparatus having a wireless communication function capable of selectively connecting a suitable wireless communication module thereto according to the wireless communication environment of the mobile device.

Further another object of the present invention is to provide a security certification and storage combined apparatus having a wireless communication function capable of generating and displaying an OTP (One-Time Password) fit for the purpose thereof among the multiple OTPs, which can be independently used in different organizations (financial or non-financial institutions) without separate power means or selection means.

In order to accomplish this object, there is provided a security certification and storage combined apparatus having a wireless communication, comprising: a wireless communication module for transmitting and receiving data with a mobile device; an USB connector connected to an electronic device having an USB port; a security memory unit for allowing approach of an authentic user and storing data of the authentic user therein; a security token module for performing an user authentication by using a certificate verification and a digital signature key of the certificate verification; and a control unit for controlling the security memory unit and the security token module for performing the user authentication, encrypting the user data inputted through the wireless communication module or the USB connector after user certification, thereby storing it in the security memory unit or providing the encrypted data stored in the security memory unit to the authentic user through the wireless communication module or the USB connector, and controlling the security token module so as to perform the user authentication by using the certificate verification and the digital signature key of the certificate verification.

Preferably, the wireless communication module comprises a first wireless communication module for using a first frequency band as a communication frequency band and a second wireless communication module for using a second frequency band, which is lower than the first frequency band.

Preferably, the security certification and storage combined apparatus having the wireless communication further comprises a communication module selection unit for connecting any one of the first wireless communication module and the second wireless communication module to the control unit.

Preferably, the communication module selection unit comprises: an operation switch unit for selecting any one of the first wireless communication module and the second wireless communication module by means of the user; and a communication connection unit for connecting the selected wireless communication module to the control unit according to an operation of the operation switch unit, thereby performing the wireless communication with the mobile device through the selected wireless communication module.

Preferably, the communication module selection unit comprises: a frequency detection unit for detecting a frequency of a wireless signal received from the wireless communication module or the second wireless communication module; and a communication connection unit for selectively connecting the first wireless communication module and the second wireless communication module to the control unit according to the detected frequency information based on a frequency information detected by the frequency detection unit, thereby performing the wireless communication with the mobile device through the selected wireless communication module.

Preferably, the frequency detection unit comprises: a RF amplification unit for amplifying the wireless signal received from the first wireless communication module and the second wireless communication module; a band pass filter unit for filtering the amplified wireless signal; and a frequency band determination unit for detecting the frequency band of the wireless signal passing through the band pass filter unit.

Preferably, the security certification and storage combined apparatus having the wireless communication further comprises an OTP generation module for storing different seed values therein so as to generate different OTPs according to the certification authorities, generating the OTP value for authentication of the corresponding certification authorities by using the corresponding seed value and time information as an input value of an encryption algorithm, and sending the OTP value to an authentication server, thereby performing the user certification, wherein the control unit serves to analyze the authentication process during OTP authentication, extract a type of the certification authority, and then generate the OTP value by using the seed value corresponding to the type of the certification authority.

Preferably, the OTP generation module comprises: a first memory unit for storing a seed value corresponding to a financial institution; a second memory unit for storing a seed value corresponding to a non-financial institution; a memory selection unit for selecting any one of the first memory unit and the second memory unit according to a control signal of the control unit; and an OTP generation unit for generating the OTP by using the seed value stored in the memory unit selected by the memory selection unit.

Preferably, the authentication process analysis is any one of a website access information analysis, a notice information analysis of the website, and a type information analysis of the authentication process.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a security certification and storage combined apparatus having a wireless communication function according to a first embodiment of the present invention;

FIG. 2 is a block diagram illustrating a security certification and storage combined apparatus having a wireless communication function according to a second embodiment of the present invention;

FIG. 3 is a block diagram illustrating details of a communication module selection unit of FIG. 2;

FIG. 4 is a block diagram illustrating details of a frequency detection unit of FIG. 3;

FIG. 5 is a block diagram illustrating a security certification and storage combined apparatus having a wireless communication function according to a third embodiment of the present invention; and

FIG. 6 is a block diagram illustrating details of an OTP generation module FIG. 5.

### DETAILED DESCRIPTION OF THE PREFERRED EMBODIMENTS

Hereinafter, an exemplary embodiment of the present invention will be described in detail with reference to the accompanying drawings.

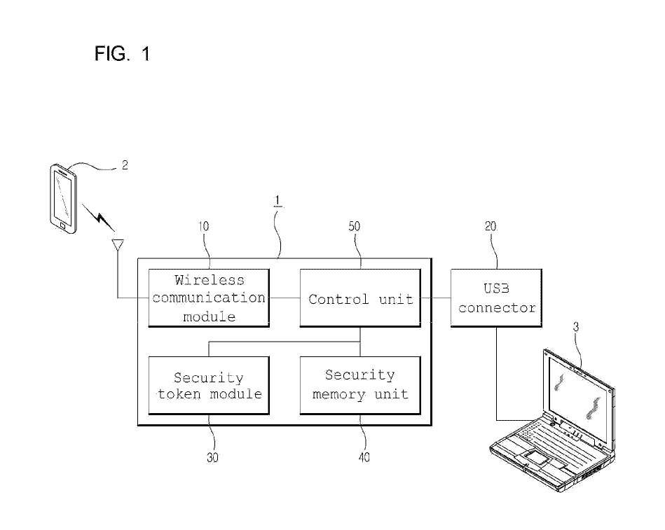

FIG. 1 is a block diagram illustrating a security certification and storage combined apparatus having a wireless communication function according to a first embodiment of the present invention.

As shown in to FIG. 1, the security certification and storage combined apparatus (1; hereinafter, security certification and storage combined apparatus) having the wireless communication function according to a first embodiment the present invention includes a wireless communication module 10, an USB connector 20, a security token module 30, a security memory unit 40, and a control unit 50.

The wireless communication module 10 serves to transmit and receive data with a mobile device 2 through a wireless communication so as to utilize the security certification and storage combined apparatus in the mobile devices 2 such as a smartphone, and a tablet PC etc., which are not equipped with an USB interface. That is, since the mobile devices 2 is provided with the wireless communication module 10 using a short-range wireless, besides mobile communication modules such as 3 Generation Mobile Communication or 4 Generation Mobile Communication, it can authenticate users through an access to the security certification and storage combined apparatus 1 or it can access the data stored in the security memory unit 40 after user certification.

Here, the wireless communication module 10 for wireless-communicating with the mobile devices 2 may be any short-range wireless module such as a wireless LAN, a NFC (Near Field Communication), and a Bluetooth communication etc.

The USB connector 20 is a terminal for connecting to USB ports of the electronic device. That is, it is configured to connect to the PC having the USB port such as a general security USB besides the mobile device.

The security token module 30 serves to store a certificate verification and a digital signature key of the certificate verification for safely storing and using the certificate verification therein and, perform an encryption function, a digital signature key generation function, a digital signature function, and perform an user authentication function by using the digital signature key of the certificate verification. Here, in order to more increase the security thereof, it is possible to perform the user authentication function by using the password, the certificate verification, and the digital signature key of the certificate verification.

The security memory unit 40 serves to allow approach of an authentic user and store data of the authentic user therein.

The control unit 50 serves to control the security memory unit 40 and the security token module 30 for performing the user authentication. That is, the control unit 50 serves to encrypt the user data inputted through the wireless communication module 10 or the USB connector 20 after user certification, thereby storing it in the security memory unit 40 or providing the encrypted data, which is stored in the security memory unit 40, to the authentic user through the wireless communication module 10 or the USB connector 20. Also, the control unit 50 serves to control the security token module 30 so as to perform the user authentication function by using the certificate verification and the digital signature key of the certificate verification.

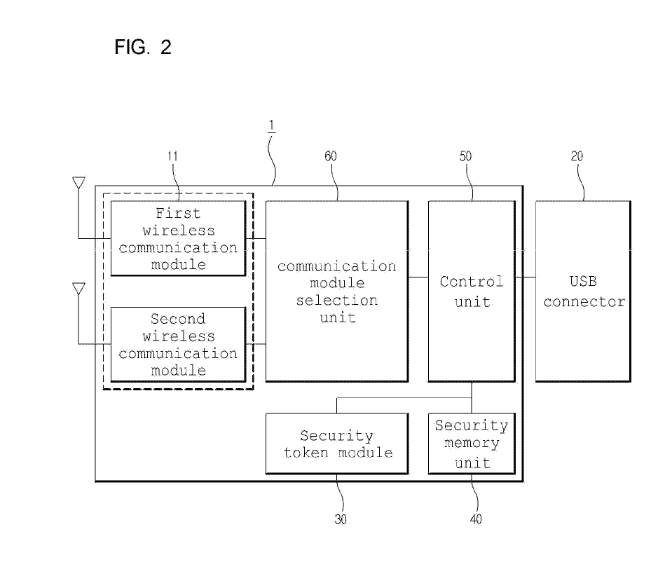

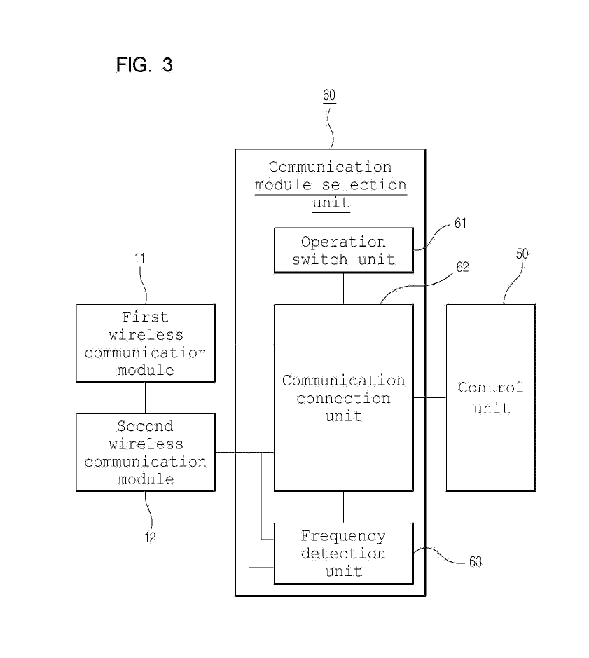

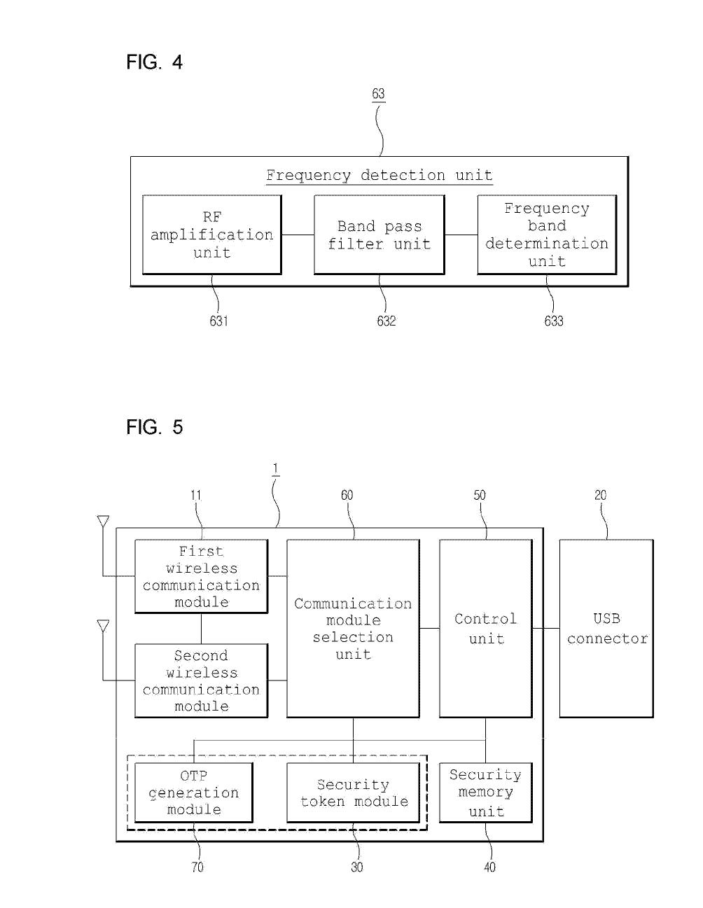

FIG. 2 is a block diagram illustrating a security certification and storage combined apparatus having a wireless communication function according to a second embodiment of the present invention, FIG. 3 is a block diagram illustrating details of a communication module selection unit of FIG. 2, and FIG. 4 is a block diagram illustrating details of a frequency detection unit of FIG. 3.

As shown in FIG. 2, the security certification and storage combined apparatus having the wireless communication function according to the second embodiment of the present invention further includes two wireless communication modules 11 and 12 and a communication module selection unit 60 for connecting any one of two wireless communication modules 11 and 12 to the control unit 50. Since other elements are identical with the first embodiment, overlapping descriptions are omitted here.

The first wireless communication module 11 uses a first frequency band as the communication frequency band. For example, it may be a wireless LAN module. The wireless LAN module is a local area network (LAN) capable of using a high-speed Internet within a certain distance in a place on which a wireless access point (AP) is installed. That is, it can use the high-speed Internet through the PC or the notebook computer within 50-200 meters around the place on which a wireless access point (AP) is installed. Here, the wireless LAN uses an IEEE802.11 standard. Also, the 802.11 b specification uses a 2.4 GHz frequency band and supports the speed of 11 Mbps. The 802.11a specification uses the 5 GHz frequency band and supports the maximum speeds of 54 Mbps.

The second wireless communication module 12 uses a second frequency band, which is lower than the first frequency band. For example, it may be a NFC (Near Field Communication). The NFC (Near Field Communication), which is one of wireless tag (RFID) technologies, is a contactless communication technology capable of using a 13.56 MHz frequency band. Since the communication distance is short, the security thereof is relatively excellent and the cost thereof is low. Accordingly, it is a notable next-generation short range communication technology. Also, since it can use the data reading and writing functions all together, the dongle (reader) for using the existed RFID is not required. The second wireless communication module 12 is similar to the existed short-range communications technologies such as the Bluetooth. However, there is a merit in that it is unnecessary to perform the setting between the devices like the Bluetooth.

The communication module selection unit 60 serves to selectively connect any one of the first wireless communication module 11 and the second wireless communication module 12 to the control unit 50.

As shown in FIG. 3, the communication module selection unit 60 can include an operation switch unit 61, a communication connection unit 62, and a frequency detection unit 63. As another example, it can include only the operation switch unit 61 and the communication connection unit 62 or only the communication connection unit 62 and the frequency detection unit 63.

The operation switch unit 61 serves to select any one of the first wireless communication module 11 and the second wireless communication module 12 by means of the user. The operation switch unit 61 can be installed on one side of an outer surface of the security certification and storage combined apparatus 1 according to the present invention.

The communication connection unit 62 serves to connect the selected wireless communication module to the control unit 50 according to an operation of the operation switch unit 61, thereby performing the wireless communication with the mobile device 2 through the selected wireless communication module

The frequency detection unit 63 serves to detect the frequency of a wireless signal received from the wireless communication module 11 or the second wireless communication module 12 and transmit the detected frequency information to the communication connection unit 62. That is, the frequency detection unit 63 serves to find out whether the wireless signal received from the mobile device 2 is the wireless LAN signal or the NFC signal.

The communication connection unit 62 serves to selectively connect the first wireless communication module 11 and the second wireless communication module 12 to the control unit 50 according to the detected frequency information based on the frequency information detected by the frequency detection unit 63, thereby performing the wireless communication with the mobile device 2 through the selected wireless communication module.

The frequency detection unit 63, as shown in FIG. 4, includes a RF amplification unit 631 for amplifying the wireless signal received from the mobile device 2, a band pass filter unit 632 for filtering the amplified wireless signal, and a frequency band determination unit 633 for detecting the frequency band of the wireless signal passing through the band pass filter unit 632.

As described above, the wireless LAN has a high frequency band of 2.4 GHz or 5 GHz. In the meantime, since the NFC (Near Field Communication) has a low frequency band of 13.56 MHz, if the detect the frequency band of the receiving signal.

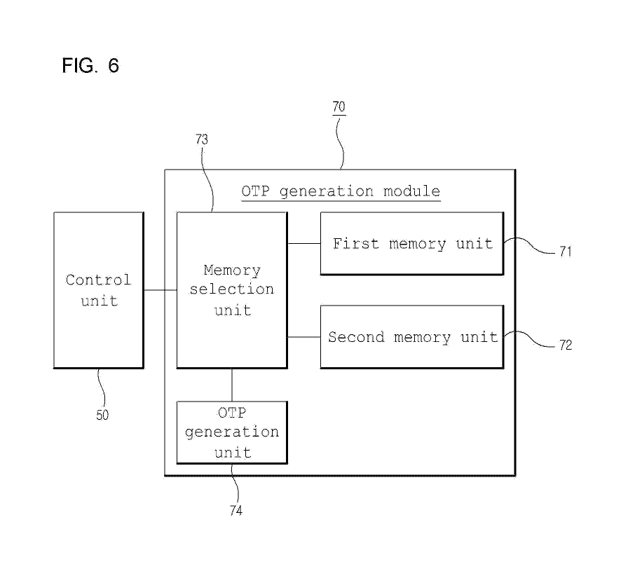

FIG. 5 is a block diagram illustrating a security certification and storage combined apparatus having a wireless communication function according to a third embodiment of the present invention and FIG. 6 is a block diagram illustrating details of an OTP generation module FIG. 5.

The security certification and storage combined apparatus having a wireless communication function according to a third embodiment of the present invention further includes an OTP generation module 70 for providing the user authentication function by using the certificate verification. That is, the OTP generation module 70 serves to generate and display the OTP (One-Time Password) fit for the purpose thereof among the multiple OTPs, which can be independently used in different organizations (financial or non-financial institutions). In the third embodiment, the OTP generation module 70 and the security token module 30 may be formed in a single smart card.

As shown in FIG. 6, the OTP generation module 70 according to the third embodiment of the present invention further can include a first memory unit 71 for storing a seed value corresponding to a financial institution, a second memory unit 72 for storing a seed value corresponding to a non-financial institution, a memory selection unit 73 for selecting any one of the first memory unit 71 and the second memory unit 72 according to a control signal of the control unit 50, and an OTP generation unit 74 for generating the OTP by using the seed value, which is stored in the memory unit selected by the memory selection unit 73.

In order to generate different OTP depending on the certification authorities, the control unit 50 serves to analyze the authentication process during OTP authentication, provide a type of the certification authority to the OTP generation module after the extraction thereof, and generate the OTP value by using the seed value corresponding to the type of the certification authority by means of the OTP generation module 70. For example, if the controls 50 judges that the certification authority is the financial institution by analyzing the authentication process, it generates an OTP for financial institution by using the seed value stored in the first memory unit 71.

Here, the authentication process analysis may be any one of a website access information analysis, a notice information analysis of the website, and a type information analysis of the authentication process.

In case of the website access information analysis, it analyzes the URL information of the website and checks out whether the corresponding URL is a sever address of the financial institution or not, thereby easily checking out the type of the institution. For this, the URL information is stored in advance according to the type of the institution.

In case of the notice information analysis of the website, it analyzes the text information listed on the website and checks out the type information of the corresponding institution. For example, if the text of the homepage screen of the connected website is analyzed, it can easily check out whether the corresponding institution is the financial institution such as a bank etc. or not.

In case of the type information analysis of the authentication process, it analyzes a process of making the current authentication. For example, if the authentication processes relate to an account transfer, it can be judged that the connected institution server is the financial institution server.

In the present invention, it can figure out the type of the certification authorities through the analysis of these certification processes. Also, since it can generate and provide the OTP value for authentication of the certification authorities by using the corresponding seed value and the time information as the input value for the encryption algorithm according to the type of the certification authorities, the user has only to input the OTP displayed on the screen of the mobile device, without considering the type of the institution for user authentication. Accordingly, there is a merit in that the user friendliness thereof is remarkably increased.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A security certification and storage combined apparatus having a wireless communication, comprising:
a wireless communication module for transmitting and receiving data with a mobile device;
an USB connector connected to an electronic device having an USB port;
a security memory unit for allowing approach of an authentic user and storing data of the authentic user therein;
a security token module for performing an user authentication by using a certificate verification and a digital signature key of the certificate verification; and
a control unit for controlling the security memory unit and the security token module for performing the user authentication, encrypting the user data inputted through the wireless communication module or the USB connector after user certification, thereby storing it in the security memory unit or providing the encrypted data stored in the security memory unit to the authentic user through the wireless communication module or the USB connector, and controlling the security token module so as to perform the user authentication by using the certificate verification and the digital signature key of the certificate verification.

2. A security certification and storage combined apparatus having a wireless communication as claimed in claim 1, wherein the wireless communication module comprises a first wireless communication module for using a first frequency band as a communication frequency band and a second wireless communication module for using a second frequency band, which is lower than the first frequency band.

3. A security certification and storage combined apparatus having a wireless communication as claimed in claim 2, further comprising a communication module selection unit for connecting any one of the first wireless communication module and the second wireless communication module to the control unit.

4. A security certification and storage combined apparatus having a wireless communication as claimed in claim 3, wherein the communication module selection unit comprises:
an operation switch unit for selecting any one of the first wireless communication module and the second wireless communication module by means of the user; and
a communication connection unit for connecting the selected wireless communication module to the control unit according to an operation of the operation switch unit, thereby performing the wireless communication with the mobile device through the selected wireless communication module.

5. A security certification and storage combined apparatus having a wireless communication as claimed in claim 3, wherein the communication module selection unit comprises:
a frequency detection unit for detecting a frequency of a wireless signal received from the wireless communication module or the second wireless communication module; and
a communication connection unit for selectively connecting the first wireless communication module and the second wireless communication module to the control unit according to the detected frequency information based on a frequency information detected by the frequency detection unit, thereby performing the wireless communication with the mobile device through the selected wireless communication module.

6. A security certification and storage combined apparatus having a wireless communication as claimed in claim 5, wherein the frequency detection unit comprises:
a RF amplification unit for amplifying the wireless signal received from the first wireless communication module and the second wireless communication module;
a band pass filter unit for filtering the amplified wireless signal; and
a frequency band determination unit for detecting the frequency band of the wireless signal passing through the band pass filter unit.

7. A security certification and storage combined apparatus having a wireless communication as claimed in claim 1, further comprising an OTP generation module for storing different seed values therein so as to generate different OTPs according to the certification authorities, generating the OTP value for authentication of the corresponding certification authorities by using the corresponding seed value and time information as an input value of an encryption algorithm, and sending the OTP value to an authentication server, thereby performing the user certification, wherein the control unit serves to analyze the authentication process during OTP authentication, extract a type of the certification authority, and then generate the OTP value by using the seed value corresponding to the type of the certification authority.

8. A security certification and storage combined apparatus having a wireless communication as claimed in claim 7, wherein the OTP generation module comprises:
a first memory unit for storing a seed value corresponding to a financial institution;
a second memory unit for storing a seed value corresponding to a non-financial institution;
a memory selection unit for selecting any one of the first memory unit and the second memory unit according to a control signal of the control unit; and
an OTP generation unit for generating the OTP by using the seed value stored in the memory unit selected by the memory selection unit.

9. A security certification and storage combined apparatus having a wireless communication as claimed in claim 7, wherein the authentication process analysis is any one of a website access information analysis, a notice information analysis of the website, and a type information analysis of the authentication process.
